(19) United States
(12) Patent Application Publication
(10) Pub. No.: US 2009/0059207 A1
(43) Pub. Date: Mar. 5, 2009

(54) METHOD AND DEVICE FOR MEASURING PHOTOLUMINESCENCE, ABSORPTION AND DIFFRACTION OF MICROSCOPIC OBJECTS IN A FLUID

(76) Inventors: Philippe Nerin, Nages Et Solorgues (FR); Benoit Merchez, Saint Andre De Sangonis (FR); Jean-Philippe Gineys, Roquedur (FR); Didier Lefevre, Saint Clement De Riviere (FR)

Correspondence Address: FITCH EVEN TABIN AND FLANNERY, 120 SOUTH LA SALLE STREET, SUITE 1600, CHICAGO, IL, 60603-3406, US

(21) Appl. No.: 12/281,906

(22) PCT Filed: Mar. 2, 2007
(86) PCT No.: PCT/FR07/00380

§ 371 Date: Sep. 5, 2008

(30) Foreign Application Priority Data
Mar. 6, 2006 (FR) 0601974

(51) Int. Cl. G01N 21/62

(52) U.S. Cl. 356/73

(57) ABSTRACT

The invention relates to a device and to a method for measuring photoluminescence in a fluid present in a measurement vessel. According to the invention, the fluid in the measurement vessel simultaneously receives at least two excitation beams coming from two optical systems. The optical systems are positioned so that their axes form between them a non-zero obtuse angle other than 180° around the measurement vessel. A measurement of light emission is deduced according to the invention from coupling data obtained from emission beams picked up simultaneously by the pickup elements. The optical systems are also positioned in such a manner that there exists at least one partial overlap beam between the excitation beam from the source of a first optical system and the emission beam picked up by the pickup element of a second optical system. The device is also provided with at least one extinction pickup element in the vicinity of at least one of the sources for picking up light at the excitation wavelength in the partial overlap beam, a measurement of absorbance and/or diffraction being deduced from data obtained from the light picked up by the extinction pickup element.

### BACKGROUND OF THE INVENTION

The present invention relates to the general field of devices and methods for measuring photoluminescence in a fluid present in a measurement vessel. Such devices and methods are used in particular for counting microscopic objects (or particles) in a fluid, e.g. a biological fluid.

More precisely, the invention relates to devices based on using partially coherent light sources, such as a light-emitting diode (LED) as means for exciting molecules, e.g. fluorescent molecules, that are present in a fluid.

Light emission by photoluminescence is a radiant phenomenon that is substantially isotropic that is induced when an excitable molecule that has previously been excited by light energy returns to its fundamental state, said excitation taking place at a wavelength that is specific to the molecule. Light emission due to fluorescence always takes place at a frequency that is lower than the excitation frequency. The measurement is generally performed away from the excitation axis of the incident light and via a chromatic filter that passes to the detector only the spectrum band that is of interest.

The invention relates in particular to developing optical and optoelectronic means that enable very weak photo-luminescence signals to be detected, such as those coming from marking biomolecules, e.g. proteins or nucleic acids.

In animal biology, measuring photoluminescence signals is particularly useful to the practitioner in order to produce a diagnosis, and more particularly a cytological diagnosis in which it is particularly useful to be able to detect and count rare cell lines, such as hematopoietic stem cells or other elements that appear in blood or some other biological liquid.

Photo-luminescence measurements of biological elements, whether the photoemission is natural or induced by a molecular probe, are in widespread use in the fields of flow cytometry and in automated cytology machines, in particular for hematological cytology.

The molecular probes used may be vital or supervital dyes, each having intrinsic affinity for some particular type of molecule, such as dyes that intercalate nucleic acids. They can also be immunological probes of the kind comprising combinations of an antibody and a dye molecule grafted thereto, generally a fluorochrome, either alone or in tandem, or sometimes a nanocrystal. The antibody will be able to bind specifically to molecules or molecule portions that are known as antigens or antigenic determinants, and they can then be counted by measuring photoluminescence.

The method of marking by implementing immunological probes is in widespread use for cytological identification, in particular with the help of flow cytometry techniques.

In order to obtain the degree of sensitivity required for such measurements, the excitation light sources must be capable of delivering sufficient energy to enable each marked biological element to be detected with sufficient sensitivity as it goes past the excitation beam.

In order to obtain this power, most cytometers or machines making use of these fluorescence techniques use laser type light sources, whether based on gaseous, solid, or other sources, or semiconductor sources such as laser diodes and other laser derivatives, such as for example a diode-pump solid state (DPSS) source.

Laser type sources give very good spatial coherence and high power, however the Gaussian structure of the laser beam affects the uniformity of the light field at the measurement point. It is necessary to make use of an optical system that is complex, and therefore expensive, in order to obtain such a field that is of uniformity greater than 0.5% at the measurement point.

The use of laser sources thus presents the major drawback of expense, and in particular with ultraviolet (UV) excitation beam devices using dye or multiple bands, that cost can be prohibitive, meaning that the use of such devices is restricted to very special circumstances in difficult fields of biological analysis.

Laser diodes are less expensive, and they present the advantage of providing high power density associated with high spatial coherence, however the available wavelengths are more restricted compared with the wavelengths that can be provided by LEDs.

On this topic, it is known, e.g. from document WO 00/57161, to use such sources having low spatial coherence, such as LEDs, in a flow cytometer.

FIG. 1 shows such a device that generally makes use of sources having low spatial coherence, such as arc lamps or LEDs. Such a device can be used for measuring photoluminescence in a measurement vessel CM having fluid for analysis, e.g. a biological fluid, injected into the center thereof. The optical system proposed is generally said to be an epifluorescence mode setup. The device comprises a light source S for generating an excitation beam, and an element (e.g. a photodetector PD) for picking up the light of a beam emitted by photoluminescence.

The terms excitation beam or light or radiation are used to mean light coming from the light source that is used for illuminating the fluid under analysis.

The terms emission beam or light or radiation are used to designate light that results from the inelastic interaction between the excitation beam and microscopic object present in the fluid under analysis, such as light emitted by fluorescence or photoluminescence.

In such an epifluorescence device, the excitation beam generated by the light source S and the emission beam picked up by the photodetector PD are on the same axis, propagating along a “system” axis X, so the same optical system can be used both for emitting and for receiving the light.

The device has a dichroic plate PC for separating the excitation and emission beams.

Advantageously, the device also has two filters F1 and F2 serving respectively to filter the light from the source S that is emitted towards the measurement vessel CM and the fluorescence light (possibly at various wavelengths) resulting from the inelastic interaction between the excitation light emitted by the source S and the microscopic object in the fluid present in the measurement vessel CM.

The optical units L1 and L3 enable the excitation and emission beams to be parallel beams when they pass through the filters F1 and F2 and the dichroic plate DC. A lens or an optical unit L2 having a large numerical aperture enables the excitation beam to be focused on a small volume centered at a measurement point M of the measurement vessel CM.

The fluorescence light coming from a microscopic object present in the fluid and passing through the point M that is illuminated by the excitation beam is focused into a parallel beam by the lens L2, passed through the plate DC, filtered by the filter F2, and received by the photodetector PD, after being focused by the lens L3.

In general, the power of the excitation beam obtained at the center wavelength selected relative to the fluorochrome in use is weak. This correspondingly reduces the discrimination capacities of prior art devices, so they have fields of application that are restricted. They can detect only high fluorescence signals, e.g. corresponding to a large number of epitopes or to markers presenting a high degree of efficiency in fluorescence.

### SUMMARY

A main object of the present invention is thus to mitigate the drawbacks presented by prior art devices by proposing a device for measuring photoluminescence and for measuring absorbance and/or diffraction that is accurate, sensitive, and inexpensive, the device comprising at least two optical systems, each including both a light source presenting low spatial coherence and delivering an excitation beam towards the measurement vessel along a “system” axis and a pickup element (or capture element) for picking up (or capturing) a photo-luminescent emission beam centered on the system axis, said optical systems operating simultaneously and being positioned so that their axes form between them a non-zero obtuse angle other than 180° about the measurement vessel, said photo-luminescence measurement being deduced from coupling together data obtained from emission beams picked up simultaneously by the pickup elements. According to the invention, the optical systems are positioned in such a manner that there exists at least one partial overlap beam between the excitation beam of the source of a first optical system and the emission beam picked up by the pickup element of a second optical system, and the device is also provided with at least one “extinction” pickup element in the vicinity of at least one of the sources for picking up light at the excitation wavelength in the partial overlap beam, with an absorbance and/or diffraction measurement being deduced from the data obtained from the light picked up by the extinction pickup element.

The invention proposes specifically increasing the number of optical systems, each using a light source of low spatial coherence, and coupling together the received emission beams. For n optical systems, this enables the excitation power at the measurement point to be n times greater than when using a single system, and it enables the photo-luminescent emission power received to be n² times greater than received from a single system, since it is received on n optical systems simultaneously. It is the isotropic nature of the photo-luminescent emission radiation that ensures that the detection sensitivity of the device is increased substantially, specifically n² times, on increasing the number n of optical systems used in epifluorescence. It then becomes possible to use light sources presenting low coherence without any harmful loss of sensitivity.

In addition, assuming that the measurement volume is excited by means of two excitation beams coming from two systems operating simultaneously, and that the light emitted by fluorescence is isotropic, fluorescence emission beams are collected simultaneously by both pickup elements of the two optical systems. Since both systems are in an epifluorescence setup, i.e. emission and reception take place along a common axis making use of the same optics, and since both systems are disposed in such a manner as to have a strictly obtuse angle between them, the fluorescence emission beam received by each optical system is angularly offset relative to the excitation beam from the other optical system.

The fluorescence emission beam that is received then suffers little interference as a result of direct light illumination, and is also twice as intense since two excitation beams are in use instead of only a single excitation beam as in prior art devices. The device of the invention is thus more accurate and more sensitive.

In addition, since the two optical systems form an obtuse angle between each other around the measurement vessel, the existence of an overlap beam, providing it is of small extent, ensures that maximum power reaches the vessel, while generating a minimum amount of interfering light.

The invention proposes using an extinction pickup element suitable for picking up the light from the overlap beam, which light presents changes of intensity that are representative of absorption and/or diffraction by a microscopic object passing through the overlap beam. The use of a suitable pickup element enables this absorption to be quantified.

In an embodiment of the invention, the device has an odd number of optical systems positioned so that their axes form between one another, in pairs, non-zero obtuse angles other than 180° about the measurement vessel.

According to a particular characteristic, the optical systems are positioned in such a manner that their axes form identical angles around the measurement vessel.

Advantageously, the number of optical systems is equal to three. The device then comprises three optical systems positioned around the measurement vessel in such a manner that their axes form identical angles between one another around the measurement vessel.

This particular characteristic serves to limit the spatial bulk around the measurement vessel while enabling the intensity of each fluorescence emission beam that is received by each pickup element from the measurement vessel CM to be multiplied by three compared with excitation using a single optical system.

In addition, the positions at 120° around the measurement vessel of the optical systems and the need to have an overlap beam require excitation and emission beams to be used that present large numerical apertures. This presents the advantage of correspondingly increasing the power for exciting the fluorochromes in the vessel.

In addition, by using such sources of large numerical aperture, a light field is obtained that is very uniform. The use of three optical systems thus provides positive synergy effects.

Furthermore, using three optical systems presents a configuration that is preferred in terms of: angles between the optical systems; available light power; overlap; light field uniformity; cost; and sensitivity.

Nevertheless, it should be observed that many of the advantages of the three-optical system configuration are independent of the presence or absence of an overlap beam and of an extinction pickup element. Furthermore, this configuration can perfectly well be implemented for measuring fluorescence without measuring extinction, using light sources having low spatial coherence, and independently of the presence or absence of an overlap beam.

In an advantageous implementation, the emission beam pickup elements are connected to a common photodetector or to a common set of photodetectors.

This implementation makes it possible to sum fluorescence signals that are received simultaneously by the pickup elements directly within the common photodetector. Data are then directly coupled, since it is acquired using a single photodetector. This characteristic serves to perform optical addition of the light signals. The photodetectors are generally sensitive to a single wavelength. The use of a single photodetector is thus more suitable when only one photo-luminescence wavelength is expected, which generally corresponds to a single excitation wavelength.

In contrast, using a set of photodetectors for the pickup elements makes it possible to detect a plurality of photo-luminescence wavelengths. This is therefore more appropriate when a plurality of photo-luminescence wavelengths are expected, which corresponds more generally to excitation at a plurality of wavelengths. By way of example, this corresponds to a configuration in which the three optical systems do not necessarily all emit light at the same wavelength.

In both configurations, the photodetectors perform optical addition of the light signals.

Advantageously, the photodetector(s) is/are connected to data processor means suitable for deducing the photo-luminescence measurement from the data received from the photodetector(s).

In an embodiment, the extinction pickup element is connected to a photodetector, itself connected to data processor means suitable for deducing an absorbance and/or diffraction measurement from data received from the photodetector.

According to a particular characteristic of the invention, the emission beam pickup elements and/or extinction beam pickup elements are optical fibers of circular or rectangular section.

According to another particular characteristic of the invention, the light sources include an LED with low spatial coherence coupled to an optical element for making the excitation beam uniform.

Advantageously, the optical element is a light conductor, e.g. an optical fiber.

In an embodiment of the invention, the measurement vessel is of polyhedral section in the plane in which the optical systems are placed, the polyhedron being such that its faces are perpendicular to the axes of the optical system.

When three optical systems are used that are placed at regular angles around the vessel, the vessel presents a section in the form of an equilateral triangle.

In another embodiment, the measurement vessel is cylindrical.

Advantageously, each optical system includes aberration correction means for correcting the aberrations introduced in the various beams by the geometry of the measurement vessel.

In a particularly advantageous application of the invention, the fluid is a biological fluid.

In this application, a device of the invention can be used for detecting and counting biological elements that have been marked to fluoresce. There are multiple applications in the field of flow cytometry in particular, and more particularly in identifying and enumerating biological cells in peripheral blood samples, or indeed in bone marrow, or in any other biological liquid.

The invention also provides a method of measuring photoluminescence and measuring absorbance and/or diffraction in a fluid present in a measurement vessel, wherein the fluid in the measurement vessel receives simultaneously at least two excitation beams coming from two optical systems, each having both a light source of low spatial coherence sending said excitation beam towards the measurement vessel along a “system” axis and a pickup element for receiving a fluorescence emission beam centered on the system axis and coming from the fluid, said optical systems being positioned so that their axes form between them a non-zero obtuse angle that is other than 180° about the measurement vessel, said measurement of photoluminescence being deduced from coupling together data obtained from the emission beams picked up simultaneously by the pickup elements. According to the invention, the optical systems are positioned in such a manner that there exists a partial overlap beam between the excitation beam from the source of a first optical system and the emission beam picked up by the pickup element of at least one second optical system, with at least one excitation light wavelength being picked up in the partial overlap beam by at least one “extinction” pickup element placed in the vicinity of at least one of the sources, and with an absorbance and/or diffraction measurement being deduced from data obtained from the light picked up by the extinction pickup element.

### BRIEF DESCRIPTION OF THE DRAWINGS

Other characteristics and advantages of the present invention appear from the following description made with reference to the accompanying drawings that show an embodiment having no limiting character. In the figures:

FIG. 1 shows a photo-luminescence measuring device as known in the prior art;

FIG. 2 is a diagram showing the principle of a photo-luminescence measuring device of the invention;

FIG. 3 shows a profile of the intensity of the light beam in the horizontal direction in the measurement vessel of a device as shown in FIG. 2;

FIG. 4 shows examples of spectral characteristics of filters and of a dichroic plate as used in a device as shown in FIG. 2;

FIG. 5 shows the absorption spectrum as a continuous line and the emission spectrum in fluorescence as a dashed line of thiazol dye;

FIG. 6 is a three-dimensional view showing the volume analyzed by the photo-luminescence measuring device of the invention;

FIG. 7 is a perspective of a first embodiment of a photo-luminescence measuring device of the invention;

FIG. 8 shows means for correcting aberrations due to the shape of the measurement vessel;

FIG. 9 shows the transmission coefficient of the emission beam as a function of the angle of incidence at a glass/air interface;

FIG. 10 is a perspective view of a second embodiment of a device of the invention for measuring a plurality of photo-luminescence values;

FIGS. 11A, 11B, and 11C show a plurality of positions for an extinction capture element in a device of the invention;

FIGS. 12A and 12B show the overlapping beams, respectively in a triangular vessel and in perspective;

FIG. 13 is a diagram showing the principle of absorption and diffraction measurements in accordance with the invention;

FIG. 14 shows the result observed at the outlet from an optical fiber used as an extinction capture element;

FIG. 15 shows the absorption spectrum as a continuous line and the emission spectrum in fluorescence as a dashed line for the dye Phycoerthyrine Cyanine 5; and

FIG. 16 is a diagram having plotted thereon the characteristics of a population of reticulocytes as measured using a device as shown in FIG. 2.

### DETAILED DESCRIPTION OF EMBODIMENT

FIG. 2 is a diagram of a photo-luminescence measuring device of the invention in a cylindrical measurement vessel CM. The device comprises three similar optical systems Ca, Cb, and Cc each centered on a respective axis Xa, Xb, and Xc. These axes Xa, Xb, and Xc form non-zero angles different from 180° between one another. In the preferred embodiment shown in FIG. 2, the optical systems Ca, Cb, and Cc are distributed regularly around the measurement vessel CM so these angles are identical and equal to 120°. These are optical systems known as epifluorescence setups, in which the same optical system is used for emitting and for receiving light. In such setups, the axes of light emitted towards the measurement vessel and for light received from the measurement vessel coincide.

Given the similarity between the optical systems Ci used, where i=a, b, or c, for convenience, the indices i=a, b, or c in the description below are specified only when using them is necessary for understanding. In the figures, only the diagram of FIG. 2 showing the principle of the device has all of the indexed references.

Each optical system Ci has a source Si for emitting an excitation beam represented by a continuous line towards the measurement vessel CM, and a pick-up element CEi for picking up the beam emitted by fluorescence, represented in part by dashed lines, on the same axis as the excitation beam along the axis Xi.

In an embodiment that is advantageous, in particular since it is inexpensive, the sources Si being bright LEDs of little spatial coherence.

It is known that bright LEDs are constituted as integrated circuits that comprise, on their surfaces, zones that are not uniform due to the presence of electrical contacts that are used for feeding electricity to the semiconductor junction. The resulting beam is therefore not uniform, and projecting the image of the diode in a measurement volume does not make it possible to achieve accurate discrimination between the microscopic objects under examination.

Thus, and in particular, in the field of biological analyses, it is not possible to obtain hematology analyzers that give correct results with such an excitation beam of mediocre uniformity.

As shown in FIG. 2, the LEDs Si are therefore advantageously coupled with respective optical elements EOi having the function of making the field of the excitation light uniform. The optical element Eoi is advantageously a light conductor, e.g. an optical fiber, or a specific optical element such as a non-imaging optical beam transformer. For example, it is possible to use fibers having a step index or a graded index with a section that is circular or rectangular.

In order to couple the light source Si with the optical element EOi, the emissive zone of the integrated circuit including the diode can be placed on the inlet face of the light conductor optical element EOi. Such coupling is inexpensive and simple to achieve. Since the temperature of the integrated circuit may reach values higher than 100° C., it is appropriate to use materials that can withstand such temperatures, e.g. silica.

Otherwise, it is possible to use light conductors EO made of plastics material by inserting a specific optical system, such as a glass bead lens made of silica or of synthetic ruby between the light conductor EO and the integrated circuit. It should also be observed that the bead lens may further improve uniformity of the excitation light field, e.g. by placing the integrated circuit in the focal plane of the bead lens. Under such conditions, the light conductor EO is illuminated with a parallel beam, each point of the source emitting a wave that is coupled into the fiber.

The divergence of the excitation beam leaving a light conductor EO is given by its numerical aperture, which, for an optical fiber, is a function of the index difference between the light-guiding portion and the cladding that surrounds it.

For example, the light conductor EO may be a silica optical fiber having a diameter of 940 micrometers (μm) and an optical aperture of 0.22. The power coupled into each fiber is 1.5 milliwatts (mW) giving a total of 4.5 mW in the measurement vessel CM. The optical fiber is placed in contact with a LED of the OSRAM trademark (of the Golden Dragon type) that is fed with a current of 2000 milliamps (mA).

In this example, the power supply to the integrated circuit may exceed data specified by the manufacturer, so it is appropriate to provide means for cooling the junction, in particular when the excitation beam is used in continuous illumination mode. A cooling circuit constituted by a radiator of low thermal resistance adjacent to a Peltier effect element can be implemented in a device of the invention, for example.

For equivalent photometric budget, cooling can be avoided when the light source is used under pulse conditions with the pulses being triggered by auxiliary means such as an optical extinction signal or an electrical impedance transducer of the type known as using the Coulter effect.

Extinction or electrical measurements, e.g. measuring resistance or impedance, are then performed upstream from the photo-luminescence measuring device of the invention in the flow direction of the fluid in the measurement vessel CM. In FIG. 2, this flow direction is perpendicular to the plane of the figure. In this way, when an analog-to-digital converter (ADC) for the emission beams is triggered by an impedance type measurement, the triggering of the excitation beams is advantageously delayed by the time taken for the detected microscopic object to go from the impedance sensor to the optical measurement point situated at the measurement point M.

This time is known, since it is given by the ratio of the distance between the two measurement points divided by the speed v of the fluid stream, which speed is itself known since it is under control. The movement of the stream is itself delivered by a hydraulic system that is additional to the setup and that includes a stepper motor or a pneumatic actuator (not shown in the figures).

In each optical system Ci, the excitation beam from the light conductor EOi is made parallel by a collimator Lli. The excitation beam is then advantageously filtered by a filter element F1i that is a bandpass filter defined by the absorption spectrum or spectra of the fluorescent components that are to be detected.

The filtered beam is then applied to a dichroic filter DCi which is a highpass filter having the function of reflecting the excitation beam towards the measurement vessel CM and of transmitting the beams emitted in fluorescence that come from the measurement vessel CM along the axis of the epifluorescence setup, going towards a photodetector PD via a filter F2i and a sensor element CEi. Optical systems L2i then serve to image the outlet faces of the optical fibers EOi in the measurement vessel CM.

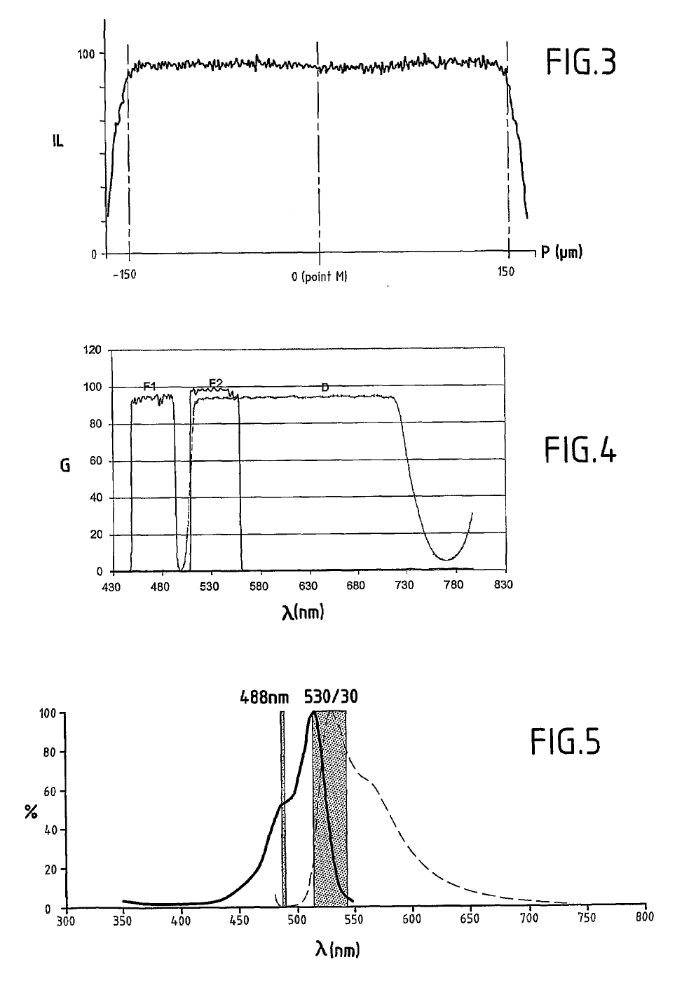

FIG. 3 shows a normalized profile of the intensity IL of the light field centered on the point M in the horizontal direction as obtained in the measurement vessel CM. Good spatial uniformity can be seen over the width of the point M, which in this example is 300 μm. This is due in particular to using excitation beams of large numerical aperture.

FIG. 4 shows an example of spectral characteristics, specifically plotting gains G as a function of wavelength, for the filters F1 and F2 and for the dichroic plate DC in an application for measuring microscopic objects that are colored by means of the orange thiazol dye or any other dye having the same spectrometric characteristics. Use is made of such a dye, having absorption properties shown as a continuous line and fluorescence properties shown as a dashed line in FIG. 5, for example in differential counting of reticulocytes, which is one of the major applications of the invention. It is also possible with the invention to detect cells having nuclei or other biological elements. As shown diagrammatically in FIG. 5, excitation is performed over a narrow band centered on 488 nanometers (nm), and fluorescence is measured over a band having a width of 30 nm centered on 530 nm.

Thus, in FIG. 4, the filter F1 is centered on the excitation wavelength of 470 nm with a width of 15 nm, the filter F2 is centered on the fluorescence emission wavelength of 540 nm with a width of 20 nm. The filter F2 has a single channel. Nevertheless, when it is desired to measure a plurality of fluorescences, a multichannel filter is advantageously used. The dichroic filter DC has a very steep rising front going from minimum transmission to maximum transmission in about 10 nm. This is a highpass filter serving to pass the fluorescence emission wavelengths while reflecting the excitation wavelengths. Such filters are available from the suppliers OMEGA and SEMROCK, for example.

Furthermore, it is known that the greater the light power sent into the measurement vessel CM, the greater the fluorescence phenomena. The magnification Gr of the optical assembly constituted by the optical units L1 and L2 is therefore a parameter that determines this power.

With a light conductor EO of rectangular section (axb), the image projected into the counting chamber presents a size (a/Gr)×(b/Gr). Writing the light power in a single light conductor as P, the power intensity at the outlet face from the light conductor EO is then P/(a×b).

In the image, focusing the excitation beam produces a power density equal of (Gr)²P/(a×b), i.e. the power density is (Gr)² times greater than the level at the outlet face of the light conductor EO.

It is therefore advantageous for the magnification Gr to be as great as possible, and it is therefore advantageous for the optical units L2 to present large numerical apertures.

With the device of FIG. 2, based on using three optical systems placed at 120° from one another, each microscopic object of the measurement volume receives three excitation beams, thereby benefiting from triple excitation of its fluorochromes.

Considering excitation of the measurement volume by a single excitation beam, given that fluorescence light is isotropic, the fluorescence emission beams are collected by the three optical units L2a, L2b, and L2c. In each optical system Ci, the emission beam is then transmitted through the dichroic plate DCi and is then filtered with the help of the filter F2i. The emission beam is then focused with the help of the optical unit L3i onto the pickup element CEi.

The pickup elements CEa, CEb, and CEc are advantageously light conductors, e.g. optical fibers, each having one end placed at the focus of one of the lenses L3a, L3b, or L3c and its other end pointing towards the sensitive surface of a single photodetector PD, which may be a photomultiplier, a simple photodiode, or an avalanche effect photodiode.

The photodetector PD receives simultaneously the emission beam coming from each of three pickup elements CEa, CEb, and CEc, and thus sums the light energies picked up by the three optical fibers CEa, CEb, and CEc.

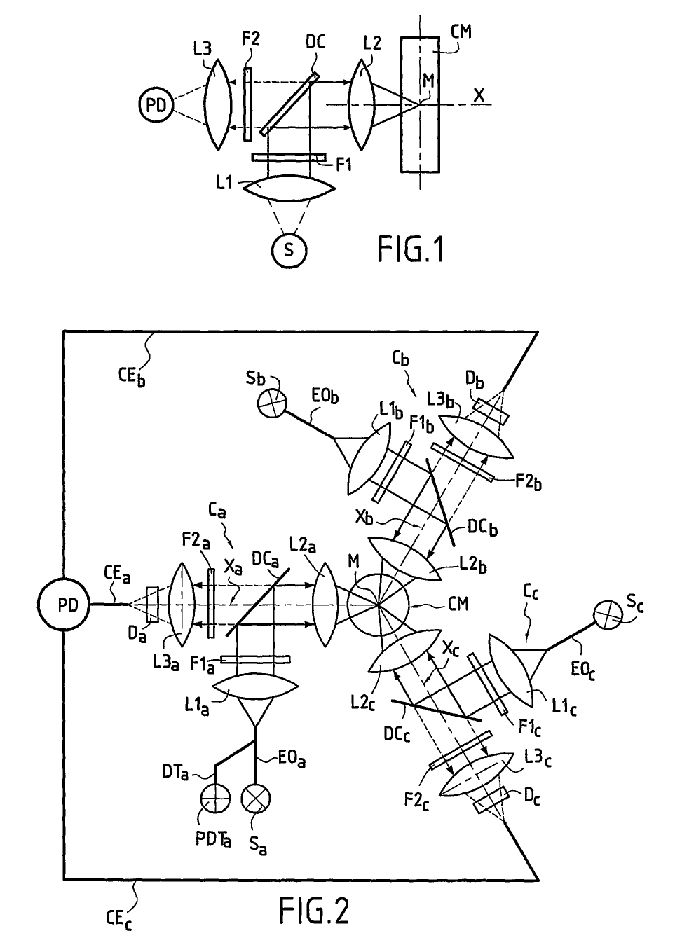

Since the device of the invention provides three simultaneous excitation beams, the same reasoning applies to each of the excitation beams. Finally, the increase in sensitivity compared with a prior art setup of the kind shown in FIG. 1 thus amounts to (32)=9.

The quantity of light collected by this assembly is therefore greater than the sum of the quantities of light collected by each of the systems taken separately, and this applies as soon as two optical systems are used in accordance with the principles of the invention.

Furthermore, as in all devices of the invention, the excitation beams in the device of FIG. 2 are offset relative to one another since the epifluorescence setup presents a non-zero obtuse angle that is different from 180°. This configuration avoids complete overlap of the excitation and emission beams, thereby minimizing the background light of the scene, which constitutes the main source of noise at the photodetector PD.

Giving consideration to using a square section vessel with four optical systems that face one another on either side of the measurement vessel, there are four opposite faces for illuminating the microscopic object for analysis, and thus for stimulating fluorescence. Nevertheless, such a configuration is unfavorable since there is then 100% overlap between the excitation and the emission beams, with the immediate consequence of the level of parasitic light being greater than in a device of the invention. Such parasitic light leads to a DC component I_{b} together with random photoelectric noise characterized by variants σ2=2 q I_{b}B, where q is the charge of the electron and B is the passband of the receiver circuit.

It should be observed that the smaller I_{b}, the more the measuring device is discriminating. I_{b} is minimized in devices of the invention since the excitation beams do not overlap or overlap only partially.

Advantageously, the device of FIG. 2 also has spatial filters D, e.g. simple pin-holes, that are placed in front of the pickup elements CE. The effect of this filtering is to eliminate certain undesirable signals, such as parasitic reflections on the walls of the measurement vessel CM, for example. It thus contributes to diminishing the component I_{b} and therefore to improving the signal-to-noise ratio.

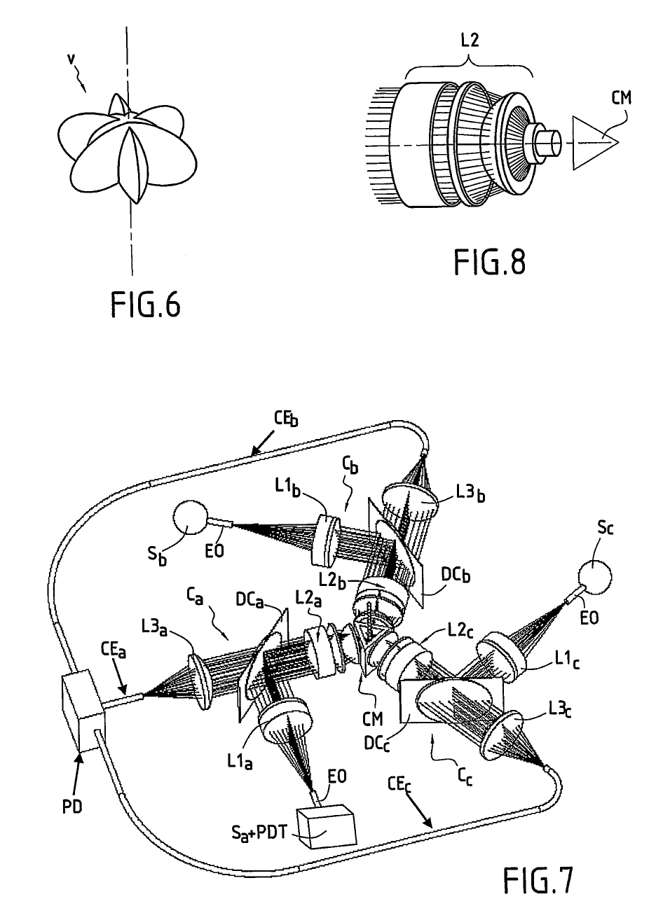

Another function of such spatial filtering is to reduce the measurement volume v centered in M, which volume is defined by the intersection of the excitation beams. FIG. 6 shows such a measurement volume v for circular light conductors OE. This volume v corresponds to all of the intersections of the three excitation beams placed at 120° from one another on the principles shown in FIG. 2.

FIG. 7 is a perspective view showing a first embodiment of a device of the invention in which a triangular measurement vessel CM is used. The measurement vessel CM is then such that its faces are perpendicular to the axes Xa, Xb, and Xc of the optical systems Ca, Cd, and Cc that are situated at 120° to one another.

In each system Ci, a dichroic plate DC is placed at 45° at the intersection of the excitation and emission beams, and it presents the spectral transmission characteristics shown in FIG. 4.

The embodiment shown in FIG. 7 is adapted to detecting and counting a single fluorescence wavelength and it uses three optical systems Ca, Cb, and Cc on the principles of the invention. This device can be used in particular for detecting and counting reticulocytes in samples of peripheral total blood. In this figure, the passage of microscopic objects in the illumination plane of the optical systems is represented by a succession of beads forming a line passing through the measurement vessel CM.

In this embodiment, the three emission beams are picked up by three pickup elements CEa, CEb, and CEc constituted by light conductors leading to a single photodetector PD. Each emission beam is spectrally filtered using a dichroic plate PC and interference filters (not shown) that are preferably positioned between the dichroic plate DC and the optical units L3.

In a variant, the spectral filtering is performed by an interference filter positioned between the three outlets from the pickup elements CEa, CEb, and CEc, and the photosensitive detector PD.

In this embodiment where the measurement vessel is triangular, it is advantageous for each optical system Ca, Cb, and Cc to include means for correcting optical aberrations introduced by the thick surface constituted by each face of the measurement vessel CM. Thus, the optical unit L2 is advantageously corrected of geometrical aberrations associated firstly with the large numerical aperture of the beam, which aperture may be greater than 0.6, and secondly with passing through thick surfaces, in particular the surface of the measurement vessel CM and the thickness of the fluid traveled through until reaching the measurement point M.

It is known that various types of aberration, known as geometrical aberrations, are responsible for reducing the power density at the measurement point M. Spherical aberration is the main aberration that needs to be corrected under these circumstances. Since the shape of the measurement vessel CM is unvarying, various solutions can be implemented for correcting spherical aberration in application of the knowledge of the person skilled in the art.

FIG. 8 shows one example of correction involving a set of lenses of adapted curvatures and refractive indices, with the gaps between two successive lenses also being a parameter of dimension that can be varied.

In FIG. 8, the correction is performed for a measurement vessel CM of equilateral triangular section. It comprises an association of three plane surfaces, e.g. made up of a wall of 2.5 mm of glass and 1.5 mm of silica.

Thus, in the example shown in FIG. 7, the optical unit L1 is an achromatic doublet that minimizes chromatic aberration at 488 nm, the optical unit L2 is made up of a set of four lenses comprising a touching doublet including the surfaces of FIG. 8. Finally, the optical unit L3 is a plano-convex lens.

It should be observed that aspherical lenses can also be used for correcting similar aberrations or aberrations of other kinds.

The lenses described correct the geometrical and chromatic aberrations introduced by passing by the thick surfaces constituted by the glass wall of the vessel and the thickness of water that extends between the wall of the measurement vessel CM and the passage of microscopic objects, e.g. cells, through the point M.

The excitation beam then passes through an air/glass first interface followed by a glass/water second interface that reduces the quantity of light by a factor equal to the Fresnel transmission at the interfaces under consideration.

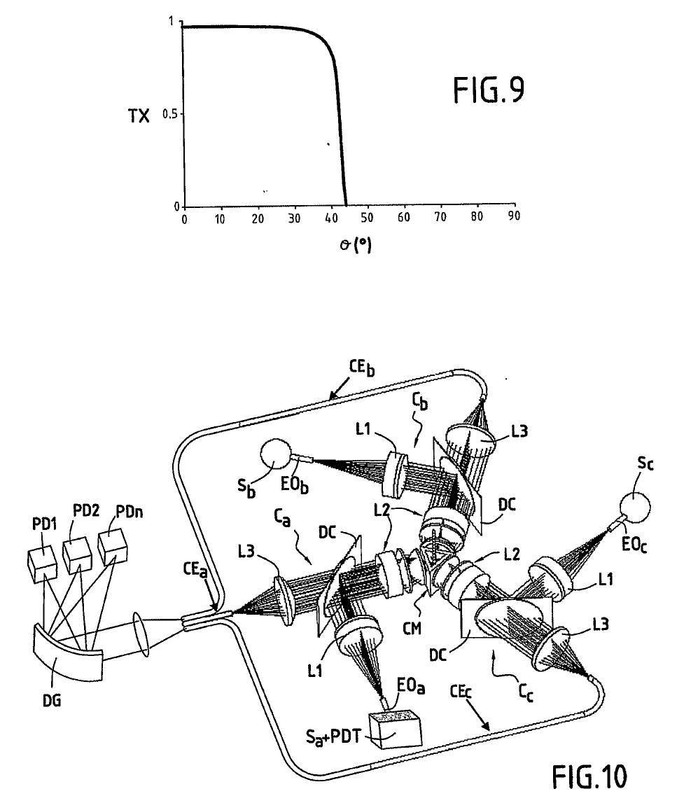

Multi-dielectric treatment can be used for minimizing the reflection of light at the interfaces under consideration. FIG. 9 shows the transmission coefficient of the emission beam as a function of angle of incidence on the material-air interface as a function of the angle of incidence for a material having a refractive index n=1.46 at the wavelength of 488 nm.

It can be seen that the phenomenon of total internal reflection limits the numerical aperture of the emission beam. If the refractive index of the transparent wall of the measurement vessel is written n, then the angle of reflection limits the geometrical angle to the value θ such that sin θ=1/n. It can thus be seen that using a measurement vessel that is cylindrical or spherical, as shown diagrammatically in FIG. 2, serves to limit the aberrations introduced by the geometry of the measurement vessel CM.

It should also be observed that the optical assembly constituted by the optical units L1 and L2 can be optimized by correcting not only geometrical aberrations, but also chromatic aberration associated with the excitation spectral bandwidth.

In addition, the optical assembly constituted by the optical units L2 and L3 can be optimized by correcting the chromatic aberration associated firstly with the fact that the fluorescent light is centered on wavelengths that are offset towards longer wavelengths, and secondly by the fact that the detection of this light takes place over a spectrum band of finite width.

It is thus useful to optimize the optical characteristics of the excitation and emission beams, e.g. by limiting aberrations calculated on the axis and at the margin of the field to less than ±20 μm at the three basic wavelengths: 0.460 μm (blue); 0.500 μm (green); and 0.600 μm (red).

In the device of FIG. 7, the fluorescence emission beams are collected by the three pickup elements CEa, CEb, and CEc, which are light conductors brought together to constitute a single beam that is coupled to a photoelectric detector PD, that may be a photomultiplier, or indeed an avalanche photodiode.

The photodetector PD sums the light energies that it picks up coming from the three optical fibers. Fluorescence is then calculated on the basis of the knowledge of the person skilled in the art, in particular after the device has been previously calibrated. A measurement of the fluorescence generated in the measurement volume v is thus obtained.

FIG. 10 is a perspective view of a second embodiment of a device of the invention adapted to measuring a plurality of fluorescent wavelengths in a fluid in a measurement vessel CM.

The microscopic objects present in the measurement vessel CM are, once more, illuminated by three excitation beams coming from the sources Si of three systems Ca, Cb, and Cc via filtering using an optional spectral filter (not shown) and a dichroic separator plate DC. In each optical system Ci, the dichroic plate DCi reflects light coming from Si towards the measurement vessel CM where L2i concentrates said light. In contrast, the dichroic plate DCi transmits longer wavelengths coming from illuminated microscopic objects so that it passes towards the pickup elements CEa, CEb, and CEc, which elements are preferably light conductors such as optical fibers.

The three pickup elements CEa, CEb, and CEc are subsequently combined on a common spectrometric detector unit that is constituted, for example, by a diffraction grating DG and n photodetectors PD1 to PDn. The n photodetectors are positioned in space relative to the grating DG so that each of them picks up and measures a band of wavelengths, each band corresponding to one of the target wavelengths of fluorescence emitted by the biological elements passing through the vessel CM. These photodetectors PD1 to PDn may be detectors selected from photodiodes, optionally avalanche effect photodiodes, e.g. arranged in a row or a strip, photomultiplier tubes, multiple optical sensors of the charge-coupled device (CCD) type, e.g. organized as a matrix or as a row.

Distinct fluorescence intensities are then obtained for a plurality of distinct wavelength bands. The presence of fluorescence at distinct wavelengths may be due to differences between the detected objects or to the presence of the plurality of wavelengths used on emission, said plurality giving rise to fluorescence at a plurality of distinct wavelengths.

One of the advantages of this particular spectrometric detection assembly is that it can be adapted to fluorescence at different wavelengths, and the device can easily be used for detecting objects having distinct characteristics without the device being modified. In addition, the position of each photodetector has an effect both on the target wavelength and on the width of the detection band.

In a variant, the three pickup elements CEa, CEb, and CEc are combined on a single detection assembly that is constituted, for example, by separator plates, possibly dichroic plates that share the light beam amongst a plurality of photodetectors PD1 to PDn.

Prior to taking the measurement, the emission beams may be filtered by means of interference filters that are adapted to the fluorophores used.

In the preferred embodiment of the invention, at least one of the optical systems, e.g. Ca in FIG. 2, includes a so-called “extinction” pickup element DT that is placed closed to the source, in this case Sa, of the system in question Ca. This extinction pickup element DT is for picking up light having the same properties in terms of wavelength as the source Sa. This light is thus reflected by the dichroic plate DC coming from the vessel CM and going towards the source Sa. The extinction pickup element DT is coupled to a photodetector PDT.

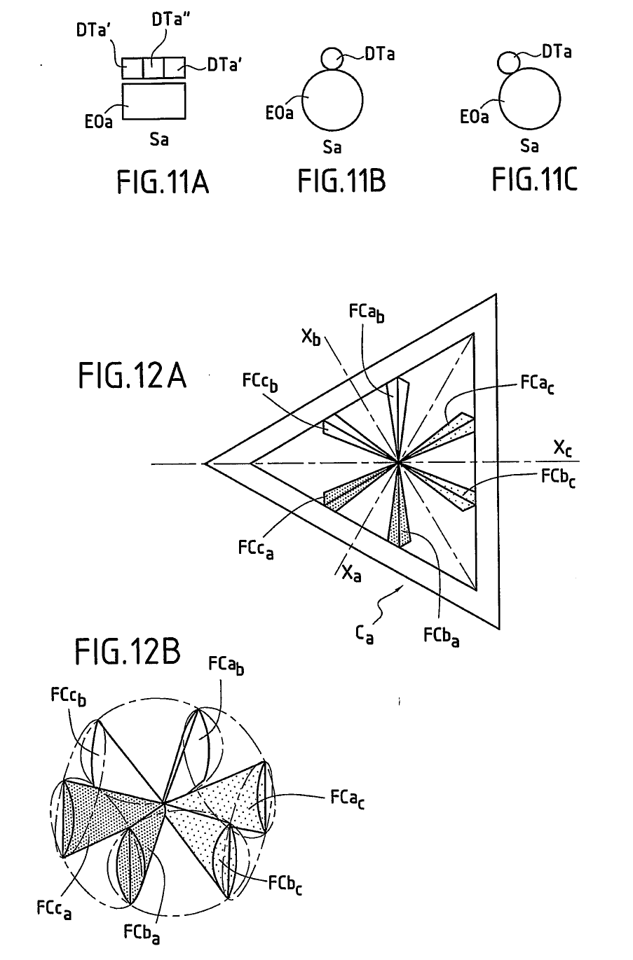

FIG. 11 shows a certain number of possible positions for an extinction pickup element DTa close to the source Sa, determined by selecting the optical element EOa that ensures that the beam produced by the source Sa is uniform.

Such an extinction pickup element DT serves to view the intersections of the excitation and emission beams, also referred to as overlap beams.

Geometrically speaking, these intersections correspond to the intersection of six cones based on the pupils of the optical units L2i and pointing towards the center of the measurement chamber CM: these overlap beams or volumes FC are shown in FIG. 12. These exist providing the numerical aperture of the lens L2 is sufficiently large.

FIG. 12A is a horizontal section through the measurement vessel CM having the axes Xa, Xb, and Xc of the three optical systems Ca, Cb, and Cc marked thereon. The overlap beams corresponding respectively to excitation by the excitation beams of the optical systems Cb and Cc as received by the system Ca are marked FCbₐ and FCcₐ. This notation is used for the other overlap beams received by the systems Cb and Cc.

FIG. 12B gives a three-dimensional view of these same overlap beams.

The existence of such overlap beams is advantageously used for making a measurement of the absorption and the diffraction produced by microscopic objects present in the measurement vessel. The extinction pickup elements DT are for picking up the light of these beams.

In FIG. 11A, the section of the optical element EOa is rectangular and is inscribed within a square having a top portion that is used for placing a plurality of extinction pickup elements DTa′ for receiving signals representative of absorption, and DTa″ for receiving signals representative of diffraction. Using two rectangular extinction pickups DTa′ that are placed on either side of the source Sa makes it possible to pick up light from overlapping beams, since the geometry of the beams is such that they are located on either side of the excitation beam. The use of a center extinction pickup DTa″ serves to pick up any diffractive light. In this example, it should be observed that the sections of the other optical elements EOb and EOc could advantageously themselves be square.

FIGS. 11B and 11C relate to two other positions for a single pickup element DTa of circular section relative to the source Sa that is represented by the section of the optical element EOa.

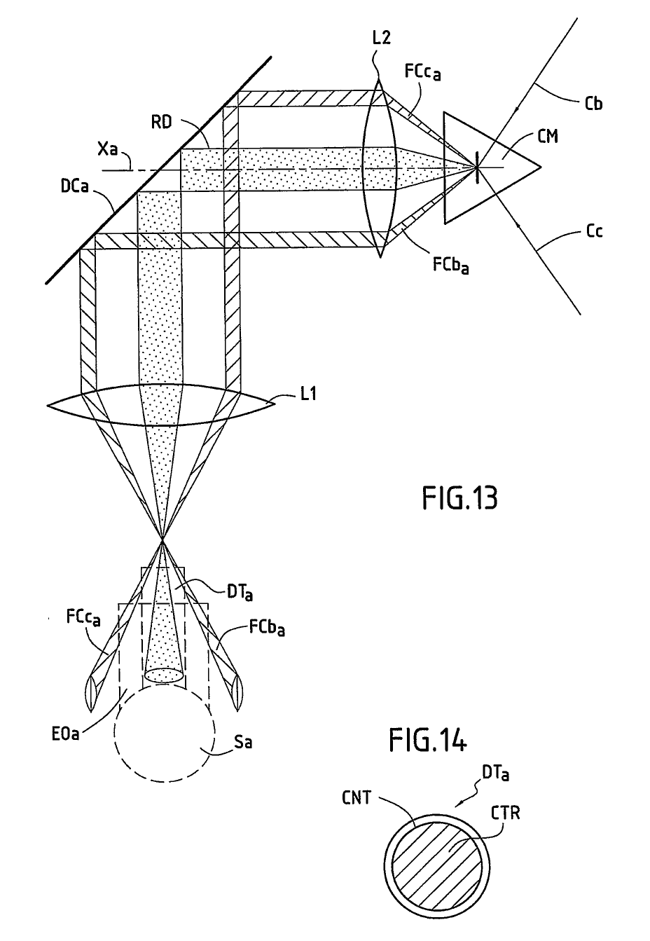

FIG. 13 shows diagrammatically the principle on which an absorption and/or diffraction measurement is made in a photoluminescence measuring device as shown in FIG. 7. For explanation purposes, it is assumed that the measurement vessel CM is illuminated by two excitation beams coming from the optical systems Cb and Cc.

The apertures of the excitation beams coming from the sources Sb and Sc are such that the overlap beams FCbₐ and FCcₐ exist together with the emission beam of the system Ca.

The emission beam of the fluorescence wavelength picked up by the system Ca (not shown) passes through the plate DCa without being deflected, while the light that is received coming from the sources Sb and Sc constituting the overlap beams is deflected by the dichroic plate DCa. In FIG. 13, only these overlap light beams FCbₐ and FCcₐ having the same wavelengths as the sources Sb and Sc are shown. They come from the measurement vessel CM and they go towards the extinction pickup element DTa via the dichroic plate DCa. The extinction pickup element DTa is advantageously an optical fiber of circular section.

In reality, there are two types of light beam having the same wavelengths as the source Sb and Sc reaching the extinction pickup element(s) DTa: those forming part of an overlap beam FCbₐ or FCcₐ, and those that do not form part thereof.

Those that do not belong to any overlap beam FCa include only rays RD that have been diffracted in the measurement vessel CM and that represent diffraction within the measurement vessel CM. Rays RD therefore do not belong to the angular sector bordered by the overlap beams FCbₐ and FCcₐ unless a microscopic object has diffracted the excitation light within the measurement vessel CM.

Those that belong to an overlap beam FCa, e.g. FCcₐ of the source Sc, include diffractive rays coming from one of the sources Sb, Sc, or even Sa if it is active, and rays of the overlap beam coming from the source Sc after passing through the measurement vessel CM without being deflected or absorbed.

Consequently, the rays of an overlap beam serve in part to reveal diffraction, but also absorption since extinction due to an absorbing microscopic object is visible in the angular sectors defined by an overlap beam.

One of the advantages of the invention is the possibility of seeing and making use of the overlap beams FC and the rays RD that are diffracted in the angular sector bordered by the overlap beams FC.

According to a particularly advantageous characteristic of the invention, an optical fiber, preferably of circular section, is used for embodying the extinction pickup element DTa, when there is only one such element. The optical characteristics of such an optical fiber serve to take advantage of the different entry angles into the fiber of rays forming part of and not forming part of an overlap beam FCbₐ or FCcₐ. As shown in FIG. 13, the rays of the overlap beams FCbₐ and FCcₐ enter the fiber with an angle relative to the axis of the fiber that is greater than the angle of the diffracted rays RD as situated in the angular sector bordered by the overlap beams. This angular property is conserved along the fiber since the rays of the overlap beams twist along the fiber but remain close to the step index line or index gradient line, whereas the other diffracted rays that entered at a smaller angle relative to the axis of the fiber are to be found throughout the section of the fiber.

Thus, as shown in the optical fiber section of FIG. 14, by emitting the outlet of the fiber DTa on a multi-element photodetector PDT, each element relating to a specific portion of the section of the fiber DTa, it can be seen that the outline CNT of the fiber DTa is continuously bright and is subjected to extinction at the moment when a microscopic object goes past, with this extinction being due to the absorption by the object. The light that is then observed on the outline CNT is representative of the absorption and also in part of the diffraction that has no reason to be zero in the angular sectors of the overlap beams.

It can also be seen that the center CTR of the fiber DTa becomes illuminated only when a microscopic object goes past, indicative of the light diffracted by said object. Assuming that the diffraction is isotropic, it is possible by connecting the photodetector PDT to processor means to deduce the intensity from the light observed in the outline of the optical fiber in order to obtain a value for the absorption.

When a plurality of extinction pickup elements are used, e.g. in the configuration of FIG. 11A, it is the presence and the intensity of light delivered by the pickups DTa′ that determines the measurements concerning absorption, and it is the presence and the intensity of light delivered by the pickup DTa″ that determines measurements relating to diffraction.

Such a use of the overlap beams is particularly advantageous for distinguishing between biological cells as a function of their absorption and/or diffraction characteristics. In particular, such extinction measurements can be used for cytological purposes where they can be interpreted as morphological or chemical information.

In order to have better control over diffraction isotropy, it can be advantageous to make the cells as spherical as possible by using chemical agents.

The above-described examples of devices of the invention thus enable the emission of light to be measured from sensitive cells insofar as each microscopic object, e.g. a biological object passing through the measurement vessel CM, receives in combination three light beams having the same wavelength and the light emitted by fluorescence is measured by a method using epifluorescence setups, the three epifluorescences being combined on a single photodetector for each fluorescence wavelength under consideration.

There follows a description of a method of distinguishing between and counting biological elements, in particular elements marked by means of antibodies or other fluorescent compounds by performing photo-luminescence measurements of the invention.

As mentioned above, differential identification and counting of biological elements is commonly performed in flow cytometry. For this purpose, the sample of blood is incubated with antibodies that are specific to the biological elements for identification. These antibodies are combined with markers, usually fluorochromes. The fluorochromes are generally selected to identify each antibody specifically, and measuring a fluorochrome therefore corresponds to identifying the antibody with which it is combined. It is thus possible to identify a plurality of different antibodies by measuring a corresponding number of different wavelengths.

In the device shown in FIG. 10, it is possible to measure a plurality of different wavelengths. It is thus possible to measure at least as many specific markers or antibodies as there are wavelengths.

These principles can be used in a very large quantity of applications. There follows a description of a generic principle suitable for being adapted to any flow cytometry marking.

As described above, the spectrum of FIG. 5 corresponds to thiazol orange. It could also apply to the Fluorescein Iso ThioCyanate (FITC) dye that is very commonly used in combination with an antibody.

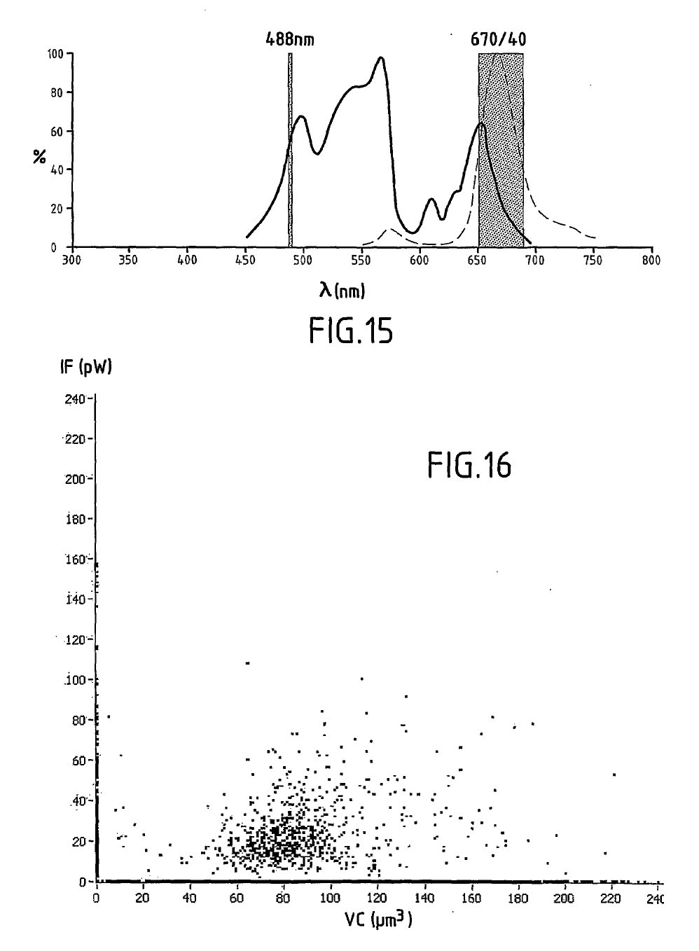

FIG. 15 relates to another dye, the Phycoerythrin Cyanine 5 tandem, that is also commonly used in flow cytometry. These two dyes can be used for identifying at least two different antibodies in the device described.

In order to analyze biological elements with a device as shown in FIG. 7 or FIG. 10, the following steps should be performed:

mixing an aliquot of total blood, e.g. 50 cubic millimeters (mm³), with the combined antibodies that are specific to target biological elements;

incubating the solution while protected from light, e.g. for 20 minutes, sufficient time for the biological elements to be marked completely and for dying intracellular substances;

injecting the resulting solution of biological elements in the measurement vessel CM in such a manner that the biological elements pass in succession, one by one, through the center M of the vessel CM in order to interact with the light illuminating said zone. Advantageously, the vessel CM is arranged in such a manner as to take measurements sequentially on the volume of all of the elements passing therethrough, using the impedance measurement method as described in patent FR 2 653 885; and

taking successive measurements for each biological element passing through the vessel CM to determine its volume by impedance measurement and to measure its fluorescence.

The measurements can be performed at a single wavelength or at a plurality of wavelengths depending on the device used and the markers used.

The steps described above have been performed for distinguishing between and counting reticulocytes using the device of FIG. 7. Reticulocytes are young versions of erythrocytes or red corpuscles. They are characterized by the intracytoplasmic presence of reticulums constituted by RNA. These traces are the remains of the nucleus being expelled on passing from the erythroblast stage to the reticulocyte stage within bone marrow. About 24 hours after this expulsion, the reticulocytes go from bone marrow into blood. In peripheral blood, where their presence does not exceed 48 hours, the ribosomes degrade so as to transform the reticulocyte into a mature erythrocyte.

The mean lifetime of a red corpuscle is 120 days, so the normal regeneration rate should be 0.83%. The normal mean percentage that is generally accepted lies in the range 0.5% to 1.5%, these values being higher in babies that are less than 3 weeks old (in the range 2% to 6%). Observing and enumerating reticulocytes thus provides an indication concerning erythroproietic activity, thus constituting a parameter that is particularly useful in monitoring medullar restoration after chemotherapy, in monitoring treatment by recombinant erythropoietin protein (rHuEpo), in the exploratory budget of anemia, or indeed in looking for a compensated hemorrhage or hemolysis.

When measuring the fluorescence of reticulocytes, the step of diluting the total blood sample is performed using a reagent containing thiazol orange, in particular as described in patent FR 2 759 166.

The results of the fluorescence and volume measurements are reconstituted and advantageously arranged so as to provide absolute and differential counts for the biological elements under observation.

It is then possible to extract the number of erythrocytes and the number and the percentage of reticulocytes on the basis of the fluorescence of the intracellular RNA.

It is also possible to calculate the immature reticulocyte fraction (IRF) on the basis of the distribution of the elements as a function of their fluorescence. The most fluorescent elements are considered as being the youngest.

FIG. 16 is a diagram plotting the results obtained by means of the invention: the reticulocytes of the population are placed on the diagram as a function of their cell volume VC (in μm³) measured by impedance measurement and plotted along the abscissa, and of the intensity IF of the fluorescence signal in picowatts (pW) and plotted up the ordinate.

In the spirit of the invention, several variants and implementations will appear clear to the person skilled in the art.

Although the invention is described above in a particularly advantageous configuration with three optical systems, it can be implemented with various numbers of optical systems, starting with two and offset in pairs by angles that are not zero and different from 180°. In particular, with such characteristics of the invention, it is possible to make use of overlapping beams as described and claimed. In addition to the fluorescence properties that are also measured, such a property is very useful for discriminating between distinct microscopic objects.

When the number of optical systems exceeds three, it is found to be necessary that at least two of the optical systems are at a non-obtuse angle, with the invention nevertheless requiring at least one pair of optical systems to be at an obtuse angle relative to each other, independently of the other optical systems. Such a characteristic is necessary in particular in order to observe an overlap beam and thus to perform an absorption and/or diffraction measurement in accordance with the invention.

In certain particular applications, it is also possible to envisage varying the wavelengths of the sources Sa, Sb, and Sc. It is thus possible to illuminate the microscopic objects passing through the measurement vessel CM with an excitation beam having two or more ranges of wavelengths, or with excitation beams at distinct wavelengths, and to measure the resulting epifluorescences individually.

It can also be envisaged to separate the pickup elements CEa, CEb, and CEc so that they can either be combined in pairs, or else connected individually each to a matching photodetector. In addition, it is possible to use various other light detection means in a device of the invention.

What is claimed is:

1. A device for measuring photoluminescence and for measuring absorbance and/or diffraction in a fluid present in a measurement vessel, the device comprising at least two optical systems, each including both a light source presenting low spatial coherence and delivering an excitation beam towards the measurement vessel along a “system” axis, and a pickup element for picking up a photo-luminescent emission beam centered on the system axis, said optical systems operating simultaneously and being positioned so that their axes form between them a non-zero obtuse angle other than 180° about the measurement vessel, said photo-luminescence measurement being deduced from coupling together data obtained from emission beams picked up simultaneously by the pickup elements, the optical systems also being positioned in such a manner that there exists at least one partial overlap beam between the excitation beam of the source of a first optical system and the emission beam picked up by the pickup element of a second optical system, and the device is also provided with at least one extinction pickup element in the vicinity of at least one of the sources for picking up light at the excitation wavelength in the partial overlap beam, with an absorbance and/or diffraction measurement being deduced from the data obtained from the light picked up by the extinction pickup element.

2. A device according to claim 1, having an odd number of optical systems positioned so that their axes form between one another, in pairs, non-zero obtuse angles other than 180° about the measurement vessel.

3. A device according to claim 2, wherein the optical systems are positioned so that their axes form identical angles between one another around the measurement vessel.

4. A device according to claim 2, having three optical systems positioned around the measurement vessel in such a manner that their axes form identical angles between one another around the measurement vessel.

5. A device according to claim 1, wherein the emission beam pickup elements are connected to a common photodetector or to a common set of photodetectors.

6. A device according to claim 5, wherein the photodetector(s) is/are connected to data processor means suitable for deducing the photo-luminescence measurement from the data received from the photodetector(s).

7. A device according to claim 1, wherein the extinction pickup element is connected to a photodetector, itself connected to data processor means suitable for deducing an absorbance and/or diffraction measurement from data received from the photodetector.

8. A device according to claim 1, wherein the emission beam pickup elements and/or extinction beam pickup elements are optical fibers of circular or rectangular section.

9. A device according to claim 1, wherein the light sources include an LED with low spatial coherence coupled to an optical element for making the excitation beam uniform.

10. A device according to claim 9, wherein the optical element is a light conductor.

11. A device according to claim 1, wherein the measurement vessel is of polyhedral section in the plane in which the optical systems are placed, the polyhedron being such that its faces are perpendicular to the axes of the optical system.

12. A device according to claim 1, wherein the measurement vessel is cylindrical.

13. A device according to claim 1, wherein each optical system includes aberration correction means for correcting the aberrations introduced in the various beams by the geometry of the measurement vessel.

14. A device according to claim 1, wherein the fluid is a biological fluid.

15. A method of measuring photoluminescence and measuring absorbance and/or diffraction in a fluid present in a measurement vessel, in which the fluid in the measurement vessel receives simultaneously at least two excitation beams coming from two optical systems, each having both a light source of low spatial coherence sending said excitation beam towards the measurement vessel along a “system” axis and a pickup element for receiving a photo-luminescence emission beam centered on the system axis and coming from the fluid, said optical systems being positioned so that their axes form between them a non-zero obtuse angle that is other than 180° about the measurement vessel, said photoluminescence measurement being deduced from coupling together data obtained from the emission beams picked up simultaneously by the pickup elements, the method being such that the optical systems are positioned in such a manner that there exists a partial overlap beam between the excitation beam from the source of a first optical system and the emission beam picked up by the pickup element of at least one second optical system, with at least one excitation light wavelength being picked up in the partial overlap beam by at least one extinction pickup element placed in the vicinity of at least one of the sources, and with an absorbance and/or diffraction measurement being deduced from data obtained from the light picked up by the extinction pickup element.
